(19) United States
(12) Patent Application Publication
(10) Pub. No.: US 2026/0112015 A1
(43) Pub. Date: Apr. 23, 2026

(54) LENS DETECTION METHOD AND ELECTRONIC DEVICE

(71) Applicant: PEGATRON CORPORATION, TAIPEI CITY (TW)

(72) Inventors: Che-Hao Wu, Taipei City (TW); Chia-Hsing Yu, Taipei City (TW)

(73) Assignee: PEGATRON CORPORATION, TAIPEI CITY (TW)

(21) Appl. No.: 19/305,120

(22) Filed: Aug. 20, 2025

(30) Foreign Application Priority Data
Oct. 21, 2024 (TW) 113139958

(51) Int. Cl. G06T 7/00; G06T 5/77; G06T 7/20

(52) U.S. Cl. CPC G06T 7/0002; G06T 5/77; G06T 7/20; G06T 2207/30196

(57) ABSTRACT

A lens detection method and an electronic device are provided in the disclosed embodiments. The method includes: obtaining a plurality of image frames captured by a lens and performing an object tracking operation on the plurality of image frames; in response to determining that a target object is tracked in at least one first image frame among the plurality of image frames and lost from tracking in at least one second image frame among the plurality of image frames, determining an occlusion status of the lens based on a relevance of the at least one second image frame captured at at least one capturing time.

### CROSS-REFERENCE TO RELATED APPLICATION

This application claims the priority benefit of Taiwan application serial no. 113139958, filed on Oct. 21, 2024. The entirety of the above-mentioned patent application is hereby incorporated by reference herein and made a part of this specification.

### BACKGROUND

### Technical Field

The disclosure relates to a detection mechanism, and in particular relates to a lens detection method and an electronic device.

### Description of Related Art

In the prior art, cameras or image capture devices typically lack specialized mechanisms to detect foreign objects on the lens or glass surface of the image capturing element. Consequently, when there are stains, dust or fingerprints on the lens, it results in abnormalities in the captured images, such as blurriness, light spots or shadows, reduced contrast, ghosting or halation, and distortion phenomena.

Furthermore, stains or fingerprints scatter light, causing the image to lose clarity. Dust particles may form bright spots or dark patches on the image. Foreign objects may also diminish color vibrancy and contrast, and even reflect light, producing halation or double-image effects. The shape or position of foreign objects may additionally cause deformation or distortion in certain areas of the image, affecting image quality and detail.

### SUMMARY

In view of this, a lens detection method and an electronic device, which may be configured to solve the above technical problems, are provided in the disclosure.

A lens detection method is provided in an embodiment of the disclosure, the lens detection method comprises the following operation. Multiple image frames captured by a lens are obtained, and an object tracking operation is performed on the image frames by an electronic device. In response to determining that a target object is tracked in at least one first image frame among the image frames and the target object is lost from tracking in at least one second image frame among the image frames, an occlusion status of the lens is determined according to relevance of the at least one second image frame captured at at least one capturing time by the electronic device.

An electronic device is provided in an embodiment of the disclosure, the electronic device includes a storage circuit and a processor. The storage circuit stores a program code. The processor is coupled to the storage circuit and accesses the program code to execute the following operation. Multiple image frames captured by a lens are obtained, and an object tracking operation is performed on the image frames. In response to determining that a target object is tracked in at least one first image frame among the image frames and the target object is lost from tracking in at least one second image frame among the image frames, an occlusion status of the lens is determined according to relevance of the at least one second image frame captured at at least one capturing time.

### BRIEF DESCRIPTION OF THE DRAWINGS

FIG. 1 is a schematic diagram of an electronic device and a lens according to an embodiment of the disclosure.

FIG. 2 is a flowchart of a lens detection method according to an embodiment of the disclosure.

FIG. 3 is an application scenario diagram according to an embodiment of the disclosure.

### DETAILED DESCRIPTION OF DISCLOSED EMBODIMENTS

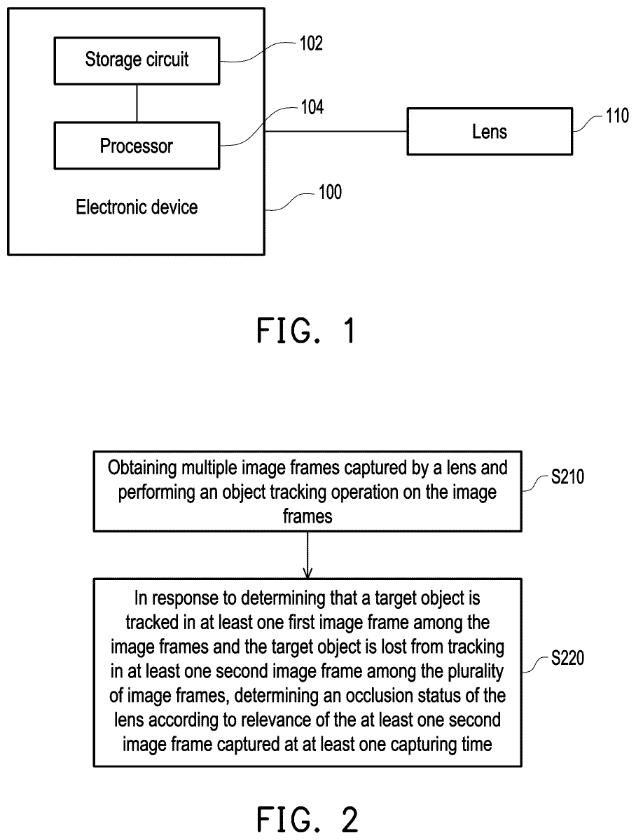

Referring to FIG. 1, FIG. 1 is a schematic diagram of an electronic device and a lens according to an embodiment of the disclosure. In different embodiments, the electronic device 100 may be implemented as various smart devices and/or computer devices, but not limited thereto.

In FIG. 1, an electronic device 100 includes a storage circuit 102 and a processor 104.

The storage circuit 102 is, for example, any type of fixed or removable random access memory (RAM), read-only memory (ROM), flash memory, a hard disk or other similar devices or a combination of these devices, and may be configured to record multiple codes or modules.

The processor 104 is coupled to the storage circuit 102 and may be a general purpose processor, a special purpose processor, a conventional processor, a digital signal processor, multiple microprocessors, one or more combined digital signal processing microprocessor, a controller, a microcontroller, an application specific integrated circuit (ASIC), a field programmable gate array (FPGA), any other type of integrated circuit, state machine, advanced RISC machine (ARM) based processor and the like.

The lens 110 is, for example, a charge coupled device (CCD) lens, a complementary metal oxide semiconductor (CMOS) lens, an infrared lens, a thermal imaging lens, a laser lens, a hyperspectral lens, a microlens array lens, a liquid lens, and an aspherical lens, but not limited thereto.

In some embodiments, the lens 110 may be disposed on a specific imaging device (e.g., a monitor), and may transmit the captured image frames to the electronic device 100 in a wired or wireless manner, but not limited thereto.

In one embodiment, the electronic device 100 may receive image frames captured by the lens 110 from the lens 110 and perform subsequent analysis accordingly.

In the embodiment of the disclosure, the processor 104 may access the module and the program code recorded in the storage circuit 102 to implement the lens detection method proposed in the disclosure, the details of which are described as follows.

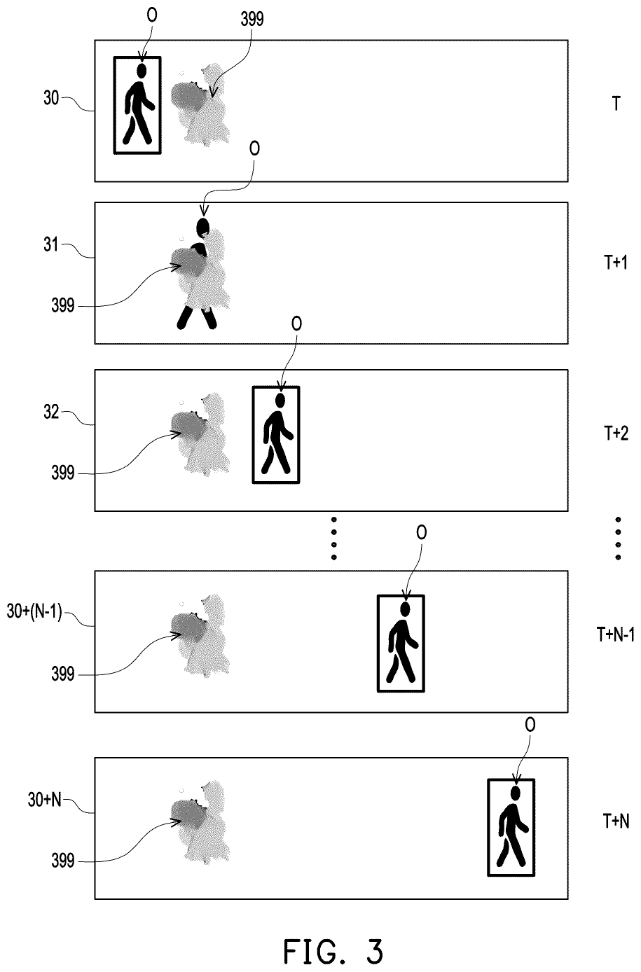

Referring to FIG. 2, FIG. 2 is a flowchart of a lens detection method according to an embodiment of the disclosure. The method of this embodiment may be executed by the electronic device 100 in FIG. 1, and the details of each step in FIG. 2 will be described below with reference to the elements shown in FIG. 1. In addition, to facilitate a clearer understanding of the disclosure, FIG. 3 is taken as an example for explanation below, in which FIG. 3 is an application scenario diagram according to an embodiment of the disclosure.

In step S210, multiple image frames 30, 31, . . . , 30+(N+1), 30+N (where N is a positive integer) captured by the lens 110 are obtained, and an object tracking operation is performed on the image frames 30 to 30+N.

In the scenario of FIG. 3, the image frames 30 to 30+N are, for example, image frames respectively captured by the lens 110 at time points T, T1, . . . , T+N−1, T+N (T is a time index), but not limited thereto.

In the embodiment of the disclosure, the image frames 30 to 30+N are, for example, obtained through continuous capture of a specific scene by the lens 110. For example, the electronic device 100 is a monitoring system, the lens 110 is a lens of a monitor having a fixed position, and the image frames 30 to 30+N are image frames obtained from a series of continuous shots captured by the lens 110 of a specific scene (such as certain locations) under surveillance over a period of time, but are not limited thereto.

In the scenario of FIG. 3, the processor 104 may perform the required object tracking operation on the image frames 30 to 30+N. For example, the processor 104 may track the target object that may appear in the image frames 30 to 30+N based on the existing object tracking algorithm and/or object tracking model. In different embodiments, the target object may be a moving object or an object with a fixed position.

In different embodiments, the object tracking algorithm used by the processor 104 is, for example, the KLT (Kanade-Lucas-Tomasi) optical flow algorithm, Mean Shift, and Kalman filter. In addition, the object tracking model used by the processor 104 is, for example, multi-object tracking (MOT), a tracking-by-detection framework, and a deep learning model such as DeepSORT, FairMOT, ByteTrack, etc., but not limited thereto.

In the scenario of FIG. 3, the processor 104 is configured to track a target object such as a (moving) human body, and the tracked target object may be marked with a corresponding indicator (e.g., a rectangular frame). However, this is provided merely as an example and is not intended to limit the possible implementations of the present disclosure.

However, since the object tracking operation performed based on the image frame is highly dependent on the image quality of the target object in the image frame, if the lens cannot clearly capture the target object due to some reasons (e.g., being (at least partially) blocked by an obstruction), the target object may be lost from tracking in the image frame, thereby reducing the performance of the object tracking operation.

Based on this, the embodiment of the disclosure may determine the occlusion status of the lens by utilizing the object tracking result through the subsequent steps in FIG. 2.

Specifically, in step S220, in response to determining that the target object is tracked in at least one first image frame among the image frames 30 to 30+N, and the target object is lost from tracking in the at least one second image frame among the image frames 30 to 30+N, the processor 104 determines the occlusion status of the lens according to the relevance of the at least one second image frame captured at at least one capturing time.

In one embodiment, the relevance of the at least one second image frame may be characterized as being associated with a temporal consistency of the at least one second image frame, but not limited thereto.

In the scenario of FIG. 3, it is assumed that after the processor 104 performs the object tracking operation on the image frames 30 to 30+N, it is determined that the target object O (e.g., a human body) is tracked in the image frames 30 and 32 to 30+N.

In this embodiment, it is assumed that there is an obstruction 399 on the lens 106, so that each of the image frames 30 to 30+N has a portion of the image area that is unclear due to the obstruction 399. In different embodiments, the obstruction 399 is, for example, various foreign objects located on the surface of the lens 106, such as dust, hair, fingerprints, water drops, etc. attached to the surface of the lens 106.

In FIG. 3, it is assumed that the target object O is blocked by the obstruction 399 at the time point T+1 corresponding to the image frame 31, so that the lens 106 cannot clearly capture the target object O, causing the processor 104 to fail to track the target object O in the image frame 31. In this case, the processor 104 may not correctly mark the target object O with a rectangular frame in the image frame 31, and thus determines that the target object O is lost from tracking in the image frame 31.

Based on this, the image frames 30, 32 to 30+N in FIG. 3 may be understood as the first image frame considered in step S220, and the image frame 31 may be understood as the second image frame considered in step S220, but it is not limited thereto.

In other embodiments, the processor 104 may also determine whether the target object O is lost from tracking based on other methods.

In one embodiment, after determining that the target object O is tracked at a certain time point (hereinafter referred to as the first time point), the processor 104 may, for example, obtain multiple reference image frames captured by the lens 110 based on an observation window at another subsequent time point (hereinafter referred to as the second time point), and determine whether the target object O is tracked for each of these reference image frames.

In one embodiment, the reference image frames are, for example, image frames captured by the lens 110 near the second time point. For example, assuming that the second time point is time point T and the length of the observation window is M (M is a positive integer), the reference image frames are, for example, M image frames captured by the lens 110 from time point T-a to time point T-a+M-1 (a is a positive integer), but not limited thereto. In different embodiments, the values of M and a may be determined by the designer as reasonable values according to requirements.

In this embodiment, the processor 104 may determine the reference image frames in which the target object O can be tracked as first reference image frames, and may determine the reference image frames in which the target object O cannot be tracked as second reference image frames.

Afterwards, the processor 104 may determine the ratio of the second reference image frames among the reference image frames. In response to determining that the ratio is higher than a preset threshold (e.g., 40%), the processor 104 may determine that the target object O is lost from tracking, and may determine at least a portion of the second reference image frames as the second image frame considered in step S220, but not limited thereto.

On the other hand, if the ratio is not higher than the preset threshold, the processor 104 may determine that the target object O has not been lost from tracking, but not limited thereto.

In one embodiment, the processor 104 may obtain multiple historical image frames associated with the specific scene, and accordingly determine the temporal consistency associated with the at least one second image frame as the relevance of the at least one second image frame.

For the convenience of explanation, the image frame 31 in FIG. 3 is still taken as the second image frame considered in step S220. In this case, the processor 104 may obtain multiple historical image frames associated with the specific scene, and accordingly determine the temporal consistency associated with the image frame 31. In some embodiments, the historical image frames are, for example, other image frames captured by the lens 110 of the specific scene before a time point corresponding to the second image frame, but not limited thereto.

In one embodiment, determining the temporal consistency of the image frame 31 may involve, for example, analyzing the changes of the historical image frames over time to identify whether the specific scene remains consistent at different times. Commonly used methods include: photometric invariance analysis, feature point matching (which may be implemented based on algorithms such as scale-invariant feature transform (SIFT) or speeded-up robust features (SURF)), background modeling and differential analysis, image entropy and texture analysis, temporal modeling and deep learning (which may be implemented based on models such as recurrent neural network (RNN) or transformer), shadow and reflection analysis, but not limited thereto.

In one embodiment, determining the temporal consistency of the image frame 31 may be determining whether the target object O in the historical image frame captured at the same time point as the image frame 31 is also lost from tracking. For example, since there is usually similar lighting at the same time of day, the target object O is likely to be lost from tracking due to similar lighting during the same time period.

In one embodiment, in response to determining that the temporal consistency associated with the at least one second image frame is normal (e.g., remains consistent at different times), the processor 104 may determine that the lens 110 is not blocked. Specifically, if the temporal consistency associated with the at least one second image frame is normal, it means that the target object O is not lost from tracking in the at least one second image frame due to the lens 110 being blocked, but may be lost from tracking due to the change of illumination in the specific scene.

In another embodiment, in response to determining that the temporal consistency associated with the at least one second image frame is abnormal (e.g., inconsistent at different times), the processor 104 may determine that the lens 110 is at least partially blocked. Specifically, if the temporal consistency associated with the at least one second image frame is abnormal, it means that the target object O is not lost from tracking due to the change of illumination in the specific scene in the at least one second image frame, but may be lost from tracking because the lens 110 is blocked.

Taking FIG. 3 as an example, the processor 104 may determine that the temporal consistency associated with the image frame 31 is abnormal, and further determine that the lens 110 is at least partially blocked (e.g., blocked by the obstruction 399), but not limited thereto.

In one embodiment, in response to determining that the lens 110 is at least partially blocked, the processor 104 may accordingly generate a notification. This notification may be used, for example, to remind relevant personnel to take corresponding treatment measures, such as cleaning the surface of the lens 110, but not limited thereto.

In one embodiment, in response to determining that the temporal consistency associated with the at least one second image frame is abnormal, the processor 104 performs an image repairing operation on the at least one second image frame based on an image repairing algorithm.

Taking FIG. 3 as an example, after the processor 104 determines that the temporal consistency associated with the image frame 31 is abnormal, the processor 104 may perform an image repairing operation on the image frame 31 based on an image repairing algorithm. Thereby, the defective area in the image frame 31 (e.g. the area affected by the obstruction 399) may be filled or restored, so that the repaired image frame 31 looks continuous and natural with other image frames.

In different embodiments, the image repairing algorithm may include, for example, a texture synthesis method, a filling diffusion method, a structure and texture merging method, a block matching method, a deep learning method, and a frequency domain repairing method, but not limited thereto.

In another embodiment, in response to determining that the temporal consistency associated with the at least one second image frame is normal (i.e., the lens 110 is not blocked), it means that there should be no defective area in the at least one second image frame caused by the lens 110 being blocked. In this case, the processor 104 may maintain the at least one second image frame (i.e., not perform image repairing), but not limited thereto.

In some embodiments, in response to determining that the temporal consistency associated with the at least one second image frame is abnormal, the processor 104 may further store related abnormality information for subsequent analysis and optimization of an algorithm for object tracking.

In addition, although the above descriptions all assume that the lens 110 is located outside the electronic device 100, in other embodiments, the lens 110 may also be built into the electronic device 100. Furthermore, in addition to determining the occlusion status of the lens 110 based on the image frames provided by the lens 110, the electronic device 100 may also determine the occlusion status of other built-in lenses and/or external lenses based on image frames provided by these lenses, but not limited thereto.

In summary, the technical solution provided by the embodiments of the disclosure may determine the occlusion status of the lens based on the relevance (e.g., temporal consistency) of the image frames when determining that the target object is lost from tracking. If the relevance of the image frames indicates that the lens is at least partially blocked, the embodiments of the disclosure may notify relevant personnel to take appropriate treatment measures, such as cleaning the lens. This may prevent the object tracking performance from being affected by obstructions (e.g., dust, fingerprints, etc.) on the lens surface. In addition, the embodiments of the disclosure may also perform a corresponding image repairing operation on the image frame when the relevance of the image frames indicate that the lens is at least partially blocked. Thereby, the repaired image frame may provide better image quality.

From another perspective, the technical solution provided by the embodiments of the disclosure may continuously monitor the contamination of the lens through automated computer vision analysis, thereby significantly improving the accuracy and efficiency of detection. Furthermore, by actively performing image repair processing, the embodiments of the disclosure minimize the impact of image contamination and defects on object tracking performance. Therefore, the technical solution provided by the embodiments of the disclosure may be applied to industrial visual inspection, security monitoring, unmanned driving and other fields, and has broad application prospects.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and their equivalents and not by the above detailed descriptions.

What is claimed is:

1. A lens detection method, comprising:
obtaining a plurality of image frames captured by a lens and performing an object tracking operation on the image frames by an electronic device; and
in response to determining that a target object is tracked in at least one first image frame among the image frames and the target object is lost from tracking in at least one second image frame among the image frames, determining an occlusion status of the lens according to relevance of the at least one second image frame captured at at least one capturing time by the electronic device.

2. The lens detection method according to claim 1, comprising:
in response to determining that the target object has been tracked at a first time point, obtaining at least one reference image frame captured by the lens based on an observation window at a second time point, and determining whether the target object is tracked for each of the at least one reference image frame;
determining that the at least one reference image frame in which the target object can be tracked as at least one first reference image frame, and determining that the at least one reference image frame in which the target object cannot be tracked as at least one second reference image frame;
determining a ratio of the at least one second reference image frame among the at least one reference image frame;
in response to determining that the ratio is higher than a preset threshold, determining at least a portion of the at least one second reference image frame as the at least one second image frame.

3. The lens detection method according to claim 1, comprising:
obtaining a plurality of historical image frames associated with a specific scene, and accordingly determining a temporal consistency associated with the at least one second image frame as the relevance of the at least one second image frame.

4. The lens detection method according to claim 3, wherein the step of determining the occlusion status of the lens according to the relevance of the at least one second image frame captured at the at least one capturing time by the electronic device comprises:
in response to determining that the temporal consistency associated with the at least one second image frame is normal, determining that the lens is not blocked by the electronic device;
in response to determining that the temporal consistency associated with the at least one second image frame is abnormal, determining that the lens is at least partially blocked by the electronic device.

5. The lens detection method according to claim 4, further comprising:
in response to determining that the temporal consistency associated with the at least one second image frame is abnormal, performing an image repairing operation on the at least one second image frame based on an image repairing algorithm by the electronic device.

6. An electronic device, comprising:
a storage circuit, storing a program code; and
a processor, coupled to the storage circuit and accessing the program code to execute:
obtaining a plurality of image frames captured by a lens and performing an object tracking operation on the image frames; and
in response to determining that a target object is tracked in at least one first image frame among the image frames and the target object is lost from tracking in at least one second image frame among the image frames, determining an occlusion status of the lens according to relevance of the at least one second image frame captured at at least one capturing time.

7. The electronic device according to claim 6, wherein the processor is configured to execute:
in response to determining that the target object has been tracked at a first time point, obtaining at least one reference image frame captured by the lens based on an observation window at a second time point, and determining whether the target object is tracked for each of the at least one reference image frame;
determining that the at least one reference image frame in which the target object can be tracked as at least one first reference image frame, and determining that the at least one reference image frame in which the target object cannot be tracked as at least one second reference image frame;
determining a ratio of the at least one second reference image frame among the at least one reference image frame;
in response to determining that the ratio is higher than a preset threshold, determining at least a portion of the at least one second reference image frame as the at least one second image frame.

8. The electronic device according to claim 6, wherein the processor is configured to execute:
obtaining a plurality of historical image frames associated with a specific scene, and accordingly determining a temporal consistency associated with the at least one second image frame as the relevance of the at least one second image frame.

9. The electronic device according to claim 8, wherein the processor is configured to execute:
in response to determining that the temporal consistency associated with the at least one second image frame is normal, determining that the lens is not blocked;
in response to determining that the temporal consistency associated with the at least one second image frame is abnormal, determining that the lens is at least partially blocked.

10. The electronic device according to claim 9, wherein the processor is further configured to execute:
in response to determining that the temporal consistency associated with the at least one second image frame is abnormal, performing an image repairing operation on the at least one second image frame based on an image repairing algorithm.
